(19) United States
(12) Patent Application Publication
(10) Pub. No.: US 2003/0165417 A1
(43) Pub. Date: Sep. 4, 2003

(54) Method for producing silicon nitride

(76) Inventor: Norbert Auner, Frankfurt (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/311,508

(22) PCT Filed: Jun. 15, 2001
(86) PCT No.: PCT/DE01/02229

(30) Foreign Application Priority Data
Jun. 17, 2000 (DE) 100 29 903.2
Jun. 17, 2000 (DE) 100 29 902.4
Jun. 17, 2000 (DE) 100 29 911.3
Aug. 16, 2000 (DE) 100 39 753.0
Aug. 16, 2000 (DE) 100 39 752.2
Aug. 16, 2000 (DE) 100 39 751.4

(51) Int. Cl. C01B 21/068

(52) U.S. Cl. 423/344

(57) ABSTRACT

A process for the production of silicon nitride (Si₃N₄) is described. According to this process nitrogen and/or nitrogen compounds are reacted with silicon and/or silicon compounds in a reaction chamber by means of a subgroup element or a subgroup element oxide. The process can be carried out in a simple and rapid manner and has a high yield.

The present invention is directed to a process for the production of silicon nitride (Si₃N₄).

It is known to produce silicon nitride by heating silicon powder to 1350-1450° C. in a nitrogen atmosphere. In this process it is disadvantageous that a relative high amount of energy is necessary on account of the heating to the indicated temperatures.

It is the object of the present invention to provide a process for the production of silicon nitride which can be carried out especially simply and economically and has a high yield.

According to the invention this object is reached by a process according to which nitrogen and/or nitrogen compounds are reacted in a reaction chamber with silicon and/or silicon compounds by means of a subgroup element or subgroup element oxide.

Surprisingly, one came to know that the silicon is activated in such a manner by the use of the subgroup element or subgroup element oxide that the N₂-cracking and thus the reaction of silicon with nitrogen is initiated or accelerated. With “subgroup elements” here the corresponding elements of the subgroups of the periodic system of elementes are meant. Subgroup element oxides are the oxides therefrom. Especially good results can be obtained with the elements of the subgroup of group I, namely Cu, Ag, Au, wherein the use of copper or copper oxide (CuO) brings along especially good results.

At the moment, it is still not clear whether the used subgroup element or subgroup element oxide operates as initiator, activator or catalyst. Anyway, it is clear that a reaction of the silicon or of the silicon compound with nitrogen for silicon nitride results by the presence of the subgroup element or subgroup element oxide, wherein this reaction is combined with a rapid temperature increase (exothermic reaction) which results in the desired especially high energy yield. Accordingly, a rapid temperature increase in the reaction chamber onto 1000° C. and more was observed.

Especially good results are obtained if a powder of silicon and/or a silicon compound is used. Especially preferred is a powder with a particle size of about 15-25 μm. If it is emanated from the fact that the used subgroup element or subgroup element oxide initiates the desired exothermic reaction of the silicon with nitrogen, obviously, the initiating temperature is the lower the lower the particle size of the silicon or of the silicon compound is.

The subgroup element or subgroup element oxide is preferrably used in powder form either, practically as mixture with the powder of silicon and/or the silicon compound. According to an especially preferred embodiment the silicon and/or the silicon compounds are reacted as powder coated with the subgroup element or subgroup element oxide.

Practically, a powder of silicon and/or a silicon compound with activated surface is used.

According to a special variant of the process, in a first step the reaction with the subgroup element or subgroup element oxide is initiated, especially by external heating and/or carrying out an exothermic pre-reaction. For example, such a pre-reaction can be carried out with chloromethane wherein from the reaction of silicon and chloromethane sufficient adiabatic heat is generated in order to start the reaction of silicon with the subgroup element or subgroup element oxide.

According to another alternative of the inventive process a mixture of silicon and/or silicon compound and the subgroup element or subgroup element oxide is only used as ignition mixture in the reactor since the reaction of silicon with N₂ generates sufficient heat in order to be self-maintaining. On account of the small particle size the used powder mixture is substantially gas-impermeable so that the nitrogen introduced into the reaction chamber is only pressed upon as gas and a reaction front runs through the reaction chamber. According to another variant of the inventive process the reaction mixture is provided in porous form (is conditioned) and the nitrogen gas is passed through the mixture (bulk material). The method has advantages for the cooling of the reactor and enables the use of gas mixtures (nitrogen and inert gas) in order to control the heat development by the reaction. Furthermore, the heat development in the reactor occurs locally more homogeneous.

With the inventive process preferably nitrogen gas is used. In contrast to the known methods for preparing silicon nitride by heating silicon powder onto 1250-1450° C. in a nitrogen atmosphere, according to the inventive process very low initiating temperatures (about 100-300° C.) are necessary in order to let the reaction take place exothermally. Of course, nitrogen-containing mixtures or nitrogen compounds can be used either if by this the desired reaction course with silicon is obtained with the initiating, activating or catalyzing effect of the added subgroup element or subgroup element oxide.

Preferably, copper or copper oxide is used as subgroup element or subgroup element oxide wherein copper oxide (CuO) is especially preferred.

When using silicon compounds, preferably silicon hydride compounds, especially silanes, particularly silane oils, are used, wherein such compounds are preferred which have a chain length of Si₅H₁₂ to Si₉H₂₀. Such silanes have the consistency of paraffin oils and can be prepared in an industrial manner. They can be pumped so that they can be supplied to a suitable raction chamber without problems.

According to an embodiment of the inventive method preferably the hydrogen of the silicon hydride compounds is burnt for water in the presence of an oxygen supplying oxidation agent for the generation of high temperatures whereupon the reaction of the nitrogen with the silicon by means of the subgroup element or subgroup elemnt oxide follows.

Silicides and silicon alloys can be also used as silicon compounds.

In order to react the nitrogen with the silicon of silicon hydride compounds, especially silanes, it can be advantageous to add elementary silicon to the used silicon hydride compound which elementary silicon is reacted with the nitrogen by means of the used element or oxide either. In addition to elementary silicon silicides can be mixed for this purpose.

Then, the following stochiometrically 100% combustion of a normal air mixture of 20% O₂ and 80% N₂ results with a heptasilane Si₇H₁₆ by using the described measures (catalyst):

16H+4O₂→8H₂O

7Si+16N₂+additionally 17 dispersed, activated

Si→8Si₃N₄.

Accordingly, with the invention Si and/or Si compounds can be reacted in an accelerated manner with high energy yield for silicon nitride. The energy set free during this reaction can be used for operating a drive mechanism, for instance missile propulsion systems, as rocket drive systems, shaft drive systems etc.

The effect of the subgroup element or subgroup element oxide can be increased by promoters, as for instance zinc, zinc compounds.

The above-described reaction of silicon hydrides with nitrogen can be also realized with substituted silanes. For instance, tetramethylsilane (CH₃)₄Si which can be technically easily prepared can be reacted with nitrogen.

Preferably, nitrogen gas is used for carrying out the inventive process. However, mixtures of nitrogen and other gases can be used either, wherein of course air (atmospheric air) is especially preferred on account of its availability. In addition to pure silicon ferrosilicon can be used either.

If, according to the inventive process, instead of nitrogen gas air is added it is obvious that the oxygen of the air will react with the silicon either so that also SiO₂ is produced in a certain amount according to the inventive process. However, by controlling the addition of air the oxidation portion can be varied in order to obtain the intended nitrogen combustion. The optimum adjustment of the reaction will be realized by the expert in the art.

Another advantage of the inventive process consists in the feature that the produced silicon nitride can be used as starting product for further processes.

In the preceding text it was always emanated from the fact that the used subgroup element or subgroup element oxide causes an activation of the silicon. However, it cannot be excluded that this element or oxide causes instead or additionally an activation of the nitrogen so that the same can take part in the corresponding reaction with the silicon. In any case, the invention includes both possibilities.

For carrying out a variant of the inventive process, preferably the silicon and/or the silicon compounds together with the subgroup element or subgroup element oxide are preheated to 100-300° C. whereby the reaction 3Si+2N₂→Si₃N₄ is initiated. In an especially preferred manner a preheating to about 200° C. is carried out. Then the reaction Si+2CuO→SiO₂+2Cu begins. This step supplys then the necessary heat (energy) in order to start the above-cited reaction 3Si+2N₂→Si₃N₄ which begins at about 700° C.

According to a variant of the process the reaction substances are contacted with air after the preheating. Especially, air is pressed into the reactor in which the reaction takes place. By this the nitrogen necessary for the reaction is provided.

If one emanates from the fact that the silicon is produced catalytically, the terms “catalysis, catalyst, catalytical” which are used here do not exclude that even larger amounts of the catalyst as normally necessary for a catalytic reaction are added. So, the invention proposes to use up to 40% of the catalyst, especially CuO, related to the silicon or the silicon compounds.

In the above-cited manner silicon nitride can be produced in large amounts in an especially economical manner. An essential advantage of the process consists in the feature that large amounts of energy are set free which can be utilized, for instance as heating energy and as propulsion energy for any propulsion systems, as mentioned above. Accordingly, silicon nitride can be produced in the inventive manner in order to be used as starting substance for further products or as such for the known application purposes, or silicon nitride can be produced as “waste product” from corresponding processes for the generation of energy.

As regards the production of further products of silicon nitride, the invention provides with a preferred embodiment that the produced silicon nitride is reacted with a strong base or the aqueous solution thereof for a silicate.

As silicates the salts or esters of the orthosilicic acid and the combination products thereof are designated.

Silicates are or extraordinary technical importance. For instance, glass, porcelain, enamel products, clay products, cement and water glass are technical important products consisting of silicates. For instance, pure alkali silicates are used for a plurality of application purposes, for instance as binders, impregnating agents, preservation agents, for the production of washing agents or cleaning agents etc.

According to the prior art pure alkali silicates of the formulas N₄SiO₄, F₂SiO₃, N₂Si₂O₅ and N₂Si₄O₉ can be produced by melting together pure quartz sand and alkali carbonate at about 1300° C. The products obtained during the solidification of the melt at first in a glassy condition can be crystallized by longer tempering below their melting point.

In contrast, the above-cited inventive process is characterized by a high simplicity and economy. Preferably, the produced silicon nitride is discharged from a reactor used for the production of the same and is introduced into the strong base or the aqueous solution thereof. Practially, the silicon nitride is reacted with a hot base or a hot aqueous solution thereof.

A modification of this process is characterized by producing an alkali silicate by reacting the produced silicon nitride with a strong alkali lye or an aqueous solution thereof. Preferably, soda lye (NaOH) and caustic potash solution (KOH) are used. With these substances sodium silicates and potassium silicates of the composition n₂O.nSiO₂ are produced which are designated “water glass” on account of their water solubility. The silicate rich water glasses represent a “mineralic glue” and serve—especially as sodium water glass—for bonding glass and porcelain fragments, for impregnating and gluing paper, for preserving purposes, as flame retardant, for the production of silica sols, silica gels and zeoliths etc. Silicate rich potassium glass is mainly used as binder for phosphors of TV tubes, as mineral colours, paints, cleaners etc. The silicate poor water glasses serve for the production of washing and cleaning agents.

Another variant is characterized by producing an alkaline earth silicate by reacting the produced silicon nitride with a strong alkaline earth lye or an aqueous solution thereof. So, for instance, calcium silicates can be produced as additive for calcium fertilizers by reacting the silicon nitride with calcium hydroxide (Ca(OH)₂).

According to another modification the produced silicon nitride is reacted with a strong base on an aqueous solution thereof to obtain ammonia (NH₃).

This process can be carried out in an especially economical manner either. Preferably, when carrying out this process the produced silicon nitride is discharged from a reactor used for the production of the same and is introduced into the strong base or an aqueous solution thereof. Practically, the silicon nitride is reacted with a hot base or a hot aqueous solution thereof.

According to another process variant the produced silicon nitride is reacted with the strong base or an aqueous solution thereof at first to obtain an amide which is converted thereafter into an ammonium salt from which the ammonia is produced.

As strong base, preferably NaOH, KOH or Ca(OH)₂ are used. When reacting with these base further products are obtained which have various applications.

According to still another variant the obtained silicon nitride is reacted with CO₂ and H₂O to obtain ammonium carbonate ((NH₄)₂CO₃) and silicon dioxide (SiO₂), and the ammonium carbonate is thermally decomposed to obtain ammonia or is converted to ammonia by the addition of a base.

Still another embodiment of the process is directed to reacting the produced silicon nitride with hydrofluoric acid (HF) to obtain ammonia. According to this embodiment an acid, namely hydrofluoric acid, is used to obtain ammonia. Preferably, hot hydrofluoric acid or hot hydrogen fluoride is used for this acidic decomposition.

When carrying out this process the obtained silicon nitride is practically reacted with hydrofluoric acid to obtain ammoniumhexafluorosilicate ((NH₄)₂SiF₆) wherefrom ammonia and silicontetrafluoride (SiF₄) are obtained by heating.

In the following the invention is described in detail by means of examples.

### EXAMPLE 1

Silicon powder (grain size 15-25 μm) with activated surface in a mixed condition with 30% CuO is introduced into a metal or glass reactor. Chloromethane is introduced, and the reactor is heated from the outside (about 150° C.). Within short (some minutes) the reaction of silicon and chloromethane supplies enough adiabatic heat in order to initiate the reaction of silicon with copper oxide, recognizable by the formation of a copper mirror on the wall of the reactor. Now, nitrogen is introduced and reacts with the silicon for silicon nitride wherein the temperature in the reactor rapidly increases to 1000° C. With this educt ratio adiabatic temperature gradients for about 6000° C. are to be expected. On account of the small particle size the used educt mixture is substantially gas impermeable so that nitrogen is only pressed onto the material and a reaction front runs through the reactor. It is conceivable to condition the reaction mixture in porous form and to pass the nitrogen gas through the bulk material. This would result in advantages for the cooling of the reactor and would enable the use or gas mixtures (nitrogen and inert gas) in order to control the development of heat by the reaction. Furthermore, the heat development in the reactor would take place in a locally more homogeneous manner.

The preplaced reaction with chloromethane can be replaced by intensive external heating since it supplies only heat which initiates the reaction with copper oxide. This is carried out with activated silicon at 190° C.

Furthermore, it is conceivable to use the mixture of CuO and silicon powder only as igniting mixture in the reactor since the reaction of silicon with N₂ generates sufficient heat in order to be self-maintaining.

Up to now, the reaction was only carried out in insufficiently cooled reactors so that the reaction of the nitrogen had to be stopped by the introduction of argon in order to prevent a melting of the reactor. Nevertheless, the reaction yield is more than 80% (23% N in the reactor content; theoretically: 0,7×40%=28%). Notice: 6% O in the educt mixture, i.e. 3% of the Si, react with O.

### EXAMPLE 2

A mixture consisting of fine Si powder and fine CuO powder was introduced into a lying reactor provided with heating rods. Thereafter, the reactor was preheated to about 200° C. Subsequently air was pressed into the reactor. The Si₃N₄ produced in this manner was discharged from the reactor and was introduced into hot soda lye. Na silicates and gaseous ammonia were generated.

1. A process for the production of silicon nitride (Si₃N₄) according to which nitrogen and/or nitrogen compounds are reacted with silicon and/or silicon compounds in a reaction chamber by means of a subgroup element or subgroup element oxide.

2. The process according to claim 1, characterized in that a powder of silicon and/or a silicon compound is used.

3. The process according to claim 2, characterized in that a powder having a grain size of about 15-25 μm is used.

4. The process according to claim 2 or 3, characterized in that a powder of the subgroup element or subgroup element oxide is used.

5. The process according to one of the claims 2 to 4, characterized in that a powder of silicon and/or a silicon compound with activated surface is used.

6. The process according to one of the preceding claims, characterized in that in a first step, especially by external heating and/or carrying out a prereaction, the reaction with the subgroup element or subgroup element oxide is initiated.

7. The process according to claim 6, characterized in that chloromethane is introduced into the reaction chamber for carrying out the prereaction.

8. The process according to one of the preceding claims, characterized in that the silicon and/or the silicon compounds together with the subgroup element or subgroup element oxide are preheated to 100-300° C. whereby the reaction 3Si+2N₂→Si₃N₄ is initiated.

9. The process according to claim 8, characterized in that the reaction substances are contacted with air after the preheating.

10. The process according to one of the preceding claims, characterized in that a mixture of silicon and/or a silicon compound and the subgroup element or subgroup element oxide is only used as igniting mixture in the reactor.

11. The process according to one of the preceding claims, characterized in that the reaction mixture is provided in a porous form and the nitrogen gas is passed through the mixture.

12. The process according to one of the preceding claims, characterized in that copper or copper oxide is used as subgroup element or subgroup element oxide.

13. The process according to one of the preceding claims, characterized in that the silicon and/or the silicon compounds are reacted as powder coated or mixed with the subgroup element or subgroup element oxide.

14. The process according to one of the preceding claims, characterized in that silicon hydrogen compounds, especially silanes, particularly silane oils, are used as silicon compounds.

15. The process according to claim 14, characterized in that a silane/Si powder-mixture is reacted.

16. The process according to one of the preceding claims, characterized in that the hydrogen of the silicon hydrogen compounds is burnt for the generation of high temperatures in the presence of an oxidizing agent supplying oxygen, whereupon the reaction of the nitrogen with the silicon by means of the subgroup element or subgroup element oxide is carried out.

17. The process according to one of the preceding claims, characterized in that hydrocarbon compounds with incorporated silicon atoms are used as silicon compounds.

18. The process according to one of the preceding claims, characterized in that the produced silicon nitride is reacted with a strong base or an aqueous solution thereof to obtain a silicate.

19. The process according to claim 18, characterized in that the produced silicon nitride is discharged from a reactor used for the production thereof and is introduced into the strong base or the aqueous solution thereof.

20. The process according to claim 18 or 19, characterized in that an alkali silicate is produced by reacting the obtained silicon nitride with a strong alkali lye or an aqueous solution thereof or an alkaline earth silicate is produced by reacting the obtained silicon nitride with a strong alkaline earth lye or an aqueous solution thereof.

21. The process according to one of the claims 1 to 17, characterized in that the obtained silicon nitride is reacted with a strong base or an aqueous solution thereof to obtain ammonia (NH₃).

22. The process according to claim 21, characterized in that the obtained silicon nitride is discharged from a reactor used for the production thereof and is introduced into the strong base or the aqueous solution thereof.

23. The process according to claim 21 or 22, characterized in that the obtained silicon nitride is at first reacted with the strong base or the aqueous solution thereof to obtain an amide which is converted thereafter into an ammonium salt from which the ammonia is produced.

24. The process according to one of the claims 1 to 17, characterized in that the obtained silicon nitride is reacted with CO₂ and H₂O to obtain ammonium carbonate ((NH₄)₂CO₃) and silicon dioxide (SiO₂) and the ammonium carbonate is thermally decomposed or is converted to ammonia by the addition of a base.

25. The process according to one of the claims 1 to 17, characterized in that the obtained silicon nitride is reacted with hydrofluoric acid (HF) to obtain ammonia.

26. The process according to claim 25, characterized in that the obtained silicon nitride is reacted with hydrofluoric acid to obtain ammoniumhexafluorosilicate ((NH₄)₂SiF₆) from which ammonia and silicontetrafluoride (SiF₄) are produced by heating.
